(19) United States
(12) Patent Application Publication
(10) Pub. No.: US 2024/0289601 A1
(43) Pub. Date: Aug. 29, 2024

(54) Bio-Organic Artificial Neural Network System And Method

(71) Applicant: A.Y.Y.T. - Technological Applications And Data Update Ltd., Holon (IL)

(72) Inventor: Amir HANDELMAN, Hod HaSharon (IL)

(21) Appl. No.: 18/589,814

(22) Filed: Feb. 28, 2024

Related U.S. Application Data
(60) Provisional application No. 63/487,486, filed on Feb. 28, 2023.

(51) Int. Cl. G06N 3/067; G06N 3/06

(52) U.S. Cl. CPC G06N 3/0675; G06N 3/061

(57) ABSTRACT

A system and method for generating a photonic neural network device made of bio-organic materials including: array of optical inputs, light-emitted self-assembly bio-organic fibers and crystals, incorporated diffractive optical element (DOE) in the self-assembly bio-organic fibers and crystals, voltage/current/light controlled in-line polarizers and switches, conductive wires. The system is configured to support light propagation from to input to output, giving each input proper weights in form of different intensity.

### TECHNICAL FIELD

The present disclosure relates generally to neural network hardware, and, more specifically to bio-organic materials based electro-optic neural network system for edge applications.

### BACKGROUND

Harnessing the power of artificial neural network (ANN) and deep learning (DL) algorithms for daily use requires non-traditional hardware that supports fast training sessions, is energy efficient, and that enables the calculation of vector-by-matrix multiplications (VMMs). This need has given rise to several technologies especially designed for ANN processors. Among these ANN hardware architectures, electro-optical processors and all-optical processors have gained much research attention due to their superior properties over electronic ANNs, such as their smaller latency, lower energy consumption and higher bandwidth density.

Bio-organic materials-based electro-optic neural network systems may refer to neural network architectures that utilize bio-inspired materials, such as organic molecules or polymers, to perform electro-optic processing of neural signals. These systems leverage the unique properties of organic materials, including their flexibility, low energy consumption, and tunability, to implement efficient and scalable neural network functionalities. For example, various bio-organic materials-based electro-optic neural network systems may be used for edge computing:
Neural Network Architecture: These systems are built upon neural network architectures that mimic the structure and functionality of biological neural networks. They consist of interconnected artificial neurons organized into layers, with each neuron performing electro-optic signal processing tasks.
Organic Materials Integration: Bio-organic materials, such as organic semiconductors or electroactive polymers, may be integrated into the neural network as key components for signal processing. These materials may exhibit unique electro-optic properties, such as photoconductivity, electrochromism, or nonlinear optical response, which enable them to manipulate neural signals efficiently.
Electro-Optic Signal Processing: Neural signals, such as electrical impulses or optical signals representing sensory inputs or neural activity, are processed using electro-optic techniques. This may involve converting electrical signals to optical signals, modulating signal amplitude or frequency, or performing nonlinear transformations for pattern recognition tasks.
Flexible and Scalable Architecture: Bio-organic materials may offer flexibility in device design and fabrication, allowing for the implementation of neural network systems with adaptable architectures. For example, these systems may be scaled up or down to accommodate different computational requirements and may be integrated into diverse edge computing platforms.
Low Energy Consumption: Organic materials-based neural network systems may exhibit low energy consumption compared to traditional electronic devices, which may be advantageous for edge applications where energy efficiency is critical, enabling longer operation times and reducing power requirements.
Tunability and Adaptability: The properties of bio-organic materials may be tuned or modified to meet specific performance requirements, making them highly adaptable to different neural network tasks and environmental conditions, which may enable optimization of system performance for edge computing applications.

Possible use cases for edge applications based on bio-organic materials-based electro-optic neural network systems may be:
Edge AI and IoT Devices: Bio-organic materials-based neural network systems may be integrated into edge AI and IoT devices for real-time processing of sensory data, enabling intelligent decision-making at the network edge without relying on cloud-based services.
Sensor Networks and Wearable Devices: Bio-organic materials-based electro-optic neural network systems may be deployed in sensor networks and wearable devices to perform on-device processing of physiological signals, such as EEG or ECG data, for applications in healthcare monitoring, biometrics, and human-computer interaction.
Smart Sensors and Environmental Monitoring: By leveraging their low energy consumption and adaptability, bio-organic materials-based neural network systems may be deployed in smart sensors for environmental monitoring and resource management applications and providing real-time analysis of sensor data at the edge.
Autonomous Systems and Robotics: Edge computing systems equipped with bio-organic materials-based neural networks may enable autonomous decision-making and control in robotics and unmanned systems, facilitating tasks such as navigation, object recognition, and adaptive control in dynamic environments.
Cyber-Physical Systems and Industrial Automation: bio-organic materials-based electro-optic neural network systems may be integrated into cyber-physical systems and industrial automation platforms to perform predictive maintenance, process optimization, and fault detection in real-time, improving efficiency and reliability in manufacturing and infrastructure operations.

Basic neural networks are built from interconnected perceptron elements, where each perceptron performs a sum-of-products calculation of the inputs using weights and bias (determined during training). This calculation can be referred as VMM calculation, where the “vector” is the input pattern and the “matrix” is the weights and bias in the layer. The output of this VMM calculation is then passed through a nonlinear activation function, which generates the output of the neuron by (nonlinear) “thresholding” the result of the VMM computation. When the outputs of the many perceptron elements (also known as artificial neurons) in a layer are connected to all the inputs of the next layer, such network is considered fully connected. When there are no loops in the network, the network is considered a feedforward neural network (FNN). The optimized weights and bias are determined from the training phase.

Two common optical ANN-VMM implementations are: (1) wavelength division multiplexing (WDM) and (2) Mach-Zehnder Interferometers (MZIs). In the WDM-based VMM architecture (also known as “broadcast-and-weight”), every wavelength is attributed to an input node. Then, the light (at a specific wavelength) is either weighted by filters or by a set of ring resonators. The summation operation is done by detecting the spectrally weighted signals using a set of photodetectors. In the MZI-based VMM architecture, the optical VMM operation is realized by controlling the phase-shift between the MZI arms, which, in turn, produces the desired amplitudes of the output optical fields. By cascading interconnections of several 2×2 MZIs, one can construct any number of neural network layers. A noteworthy example of a photonic ANN device is Shen et. al.'s construction of a silicon photonic neural network using meshes of MZIs for vowel recognition.

Many of the photonic ANN architectures proposed to date are based on inorganic materials for the construction of both the optical interference unit (that implements the VMM calculation), and the optical nonlinearity unit (ONU) that implements the nonlinear activation function, for example, through saturable absorbers. In the ONU, a nonlinear relation between the input power Iᵢₙ, and the (transmission) output power,Iₒᵤₜ=f(Iᵢₙ) is given. Examples of the inorganic materials used for the photonic-ANN include silicon, amorphous silicon, and phase-change materials (e.g., Ge2Sb2Se5). Using bio-organic materials represents a highly attractive alternative, given that they are environmentally-friendly and have advantages in terms of large active areas, mechanical flexibility, chemical sensitivity, biocompatibility, and ease of fabrication (at low-costs) by self-assembly processes. Some organic neuromorphic devices have already been utilized in sensing and electronics, however full-photonic ANN integrated circuits that is mainly based on natural bio-organic materials are scares. The capability of such ANN based on bio-organic materials will open the avenue for a wide range of applications that require ultra-low energy consumption, specifically in healthcare, flexible photonics and biosensing.

The main application of this bio-organic photonic ANN processor is for edge computing, and it is designed to be integrated into a system of sensors, soft robots, wearable and implantable devices, flexible internet-of-things (IoT), optogenetics, optical communication applications, and food-tech (for example, solar-to-food). By combining multiple sensors with the bio-organic photonic ANN processor (also known as neuromorphic unit), the system can be upgraded into a “close-loop” feedback system, in which the ANN can either predict various parameters (for example, blood glucose level, seizures) or classify various signals, resulting in making instant, continuous and “on the spot” decisions, such as drug release delivery and sending signals with specified intensity. This ability can improve the efficiency of the system, since there is no need to compute and calculate parameters in the cloud.

It would therefore be advantageous to provide solutions that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for guide and control propagating light, including: diffraction optical element (DOE), liquid crystal display (LCD), Beam Displacer Modules (BDM), MEMS (Micro Electro Mechanical System) switch, optical fibers (including polarization maintaining (PM) fibers, Single-Mode Fibers (SMF) and Multimode Fibers (MMF), Photonic Crystals Fibers (PCF)), laser, light-emitting diode (LED), detectors, filters, beam-splitters, modulators, voltage/current/light-controlled polarizers, Mach-Zhender Interferometer (MZI), wavelength-division multiplexer (WDM).

Certain embodiments disclosed herein also include materials exhibiting light-emitted properties such as photoluminescence (PL), electroluminescence (EL), chemiluminescence (CL).

Certain embodiments disclosed herein also include neural network architectures such as reservoir computing (RC), convolutional neural network (CNN), feedforward fully-connected neural network (FFCNN) as well as pre-trained NN (PTNN).

The following embodiments and aspects thereof are described and illustrated in conjunction with systems, devices and methods which are meant to be exemplary and illustrative and not limiting in scope. In various embodiments, one or more of the above-described problems have been reduced or eliminated, while other embodiments are directed to other advantages or improvements.

According to one aspect, there is provided an Artificial Neural Network (ANN) system, comprising: at least one edge computing device, and at least one photonic ANN processor based on bio-organic materials, wherein the ANN processor is designated to allow low latency computation capacities of the edge computing device comparing to an edge computing device that rely on cloud computing connectivity, and wherein the system is configured to allow light propagation from input to output while giving each input proper weights in form of different intensity, wavelength or polarization.

According to some embodiments, the system further comprising an array of optical inputs comprised from bio-organic fibers and crystals.

According to some embodiments, the system further comprising multiple sensors configured to interact with the bio-organic photonic ANN processor as part of a medical or communication device apparatus located in close proximity to a patient.

According to some embodiments, the integration with the sensing means enables to detect and analyze various biological parameters of the patient.

According to some embodiments, the bio-organic materials are selected from a group that comprise conductive polymers, amino acids, proteins, peptides, amyloid fibrils.

According to second aspect, there is provided a photonic ANN processor based on bio-organic materials that comprises a combination of inorganic and organic materials and includes a substrate made of resilient material/s/biocompatible materials/conductive materials.

According to some embodiments, the resilient material/s allow the ANN processor to be integrated with or incorporated in various biological, electronical, optical or chemical devices, etc.

According to some embodiments, the ANN processor is configured to operate in parallel by both electrical signals and optical signals.

According to some embodiments, the ANN processor is configured to operate in only feedforward architecture, without backpropagation.

According to some embodiments, the ANN processor further comprises bio-organic optical elements designated to provide both interconnection and/or summation and thresholding.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention

FIG. 1A shows architectures for photonic vector-by-matrix multiplication (VMM).

FIG. 1B shows architectures for photonic vector-by-matrix multiplication (VMM).

FIG. 2 shows schematic of a proposed optical logic gate made of bio-organic materials. An orange stripe indicates a microstructure that emits light.

FIG. 3 shows architectures of all-optical reservoir computing with embedded optical fibers.

FIG. 4 shows architectures of all-optical reservoir computing with light coupled from free-space.

FIG. 5 shows architectures of all-optical WDM-based neural network based on single excitation photoluminescence of bio-organic materials and various polarization angles and directions.

FIG. 6 shows architectures of all-optical WDM-based neural network based on multiple excitations photoluminescence of bio-organic materials.

FIG. 7 shows a method and an example to fabricate MZI array made of bio-organic materials.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

All the architectures of the ANN processor are based on bio-organic materials or combination of inorganic/organic materials, such as metal-organic frameworks (MOFs), silicon-organic frameworks, and silicon-oxide (glass)-organic frameworks. The bio-organic optical elements will provide both the interconnects (used for axon and dendrite functionality) and/or summation and thresholding (used for soma functionality). The “optical axons” will be made of self-assembled bio-organic optical waveguides with different morphologies.

These biomaterial waveguides will passively and/or actively guide light emitted from an optical element. Examples to these biomaterials are amino-acids (such as Histidine and Lysine), peptides (such as tri-phenylalanine (FFF), di-phenylalanine (FF), di-leucine (LL)), polymers (such as Polylactic acid (PLA), Poly(methyl methacrylate) (PMMA), polyacetylene, and sPAR-CTCF), proteins (such as Lysozome, Cellulose, Silk, and Collagen), and amyloid fibrils (such as h-tau and Insulin). Some requirements from these bio-organic materials to be used as raw-materials for the ANN processor are at least one of the following properties: (1) shows EL or PL; (2) conductive; (3) enable passive and/or active waveguiding; (4) self-assembled in solution to micro-structures; (5) show high electro-optic coefficient.

The substrate of the detailed ANN processor may be made of flexible materials (such as polyimide and polyethylene terephthalate, polydimethylsiloxane (PDMS), silk), or inorganic materials (such as glass, quartz, silicon, etc.), 2D materials (graphene, van der Waals heterojunctions). In this way, the ANN processor is capable to be integrated with or incorporated in various biological, electronical, optical, and chemical sensors.

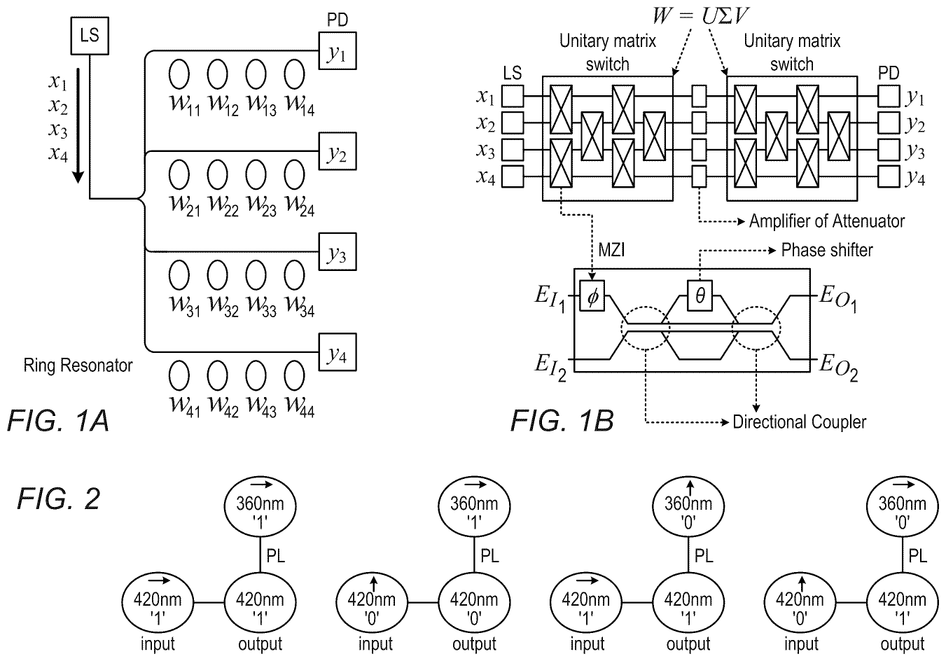

FIG. 1A shows two common architectures for photonic VMM: (a) Wavelength division multiplexing (WDM)-based VMMs and (b) Mach-Zehnder Interferometer (MZI)-based VMMs. In WDM-VMM (FIG. 1a), the input vector is represented by a wavelength multiplexed light from light sources, the weight matrix by cascaded ring resonators, and the output vector by a set of photodetectors. The WDM input signal, in which each element of the input vector is assigned a unique wavelength carrier, is equally split so that it passes through a series of ring resonators. The output is then summed up by the photodetectors. Ring resonators are placed next to a waveguide to couple only the light of a specific wavelength. When the length of the ring circumference is equal to an integer number of wavelengths which is the resonance condition, the optical signal in the waveguide is dropped to the ring and lost due to the scattering. The levels of light intensity are considered as data values in analog form, and multiplications are implemented by the ring resonators in which the loss rate can be controlled by injecting a charge into the ring or changing its temperature.

In FIG. 1B, MZI-based platform for VMM is presented. The MZI consists of two directional couplers (DCs) where two input signals are equally divided into two output ports and two-phase shifters (PSs) that modulate the input signals. The amount of phase shift (y, 0) can be controlled by charging the phase shifters or changing their temperature. The MZI can distribute the light signal of each input port to the two output ports at an arbitrary ratio by adjusting (y, 0) so that it can be used to implement a 2×2 unitary transformation. The matrix of the VMM is represented by two MZI-based unitary matrix switches and a set of either attenuators or amplifiers. The unitary matrix switches representing the M×M matrix U and N×N matrix V perform together a couple of unitary conversions. The attenuators or amplifiers represent an M×N diagonal matrix E of singular value decomposition (SVD).

FIG. 2 shows schematic of an optical logic gate (OLG) based on the appearance of photoluminescence (PL). The OLG device will exploit the fact that in some bio-organic materials (such as the amino acid Histidine, amyloid fibrils, etc.), visible fluorescence can be achieved by heating them or naturally be excitation in specific wavelengths. When combined with optical polarization, the outputs can be referred as representing binary values. For example, excitation wavelength λ₁ could reflect the binary ‘1’, excitation wavelength λ₂ the binary ‘0’, horizontal polarization the binary ‘1’, and vertical polarization the binary ‘0’. This will allow to construct various logic gates, depending on the alignment of the bio-organic microstructures. An example of such a logic gate is presented in FIG. 2, where an excitation wavelength at 360 nm causes heated microplate to emit light at 420 nm.

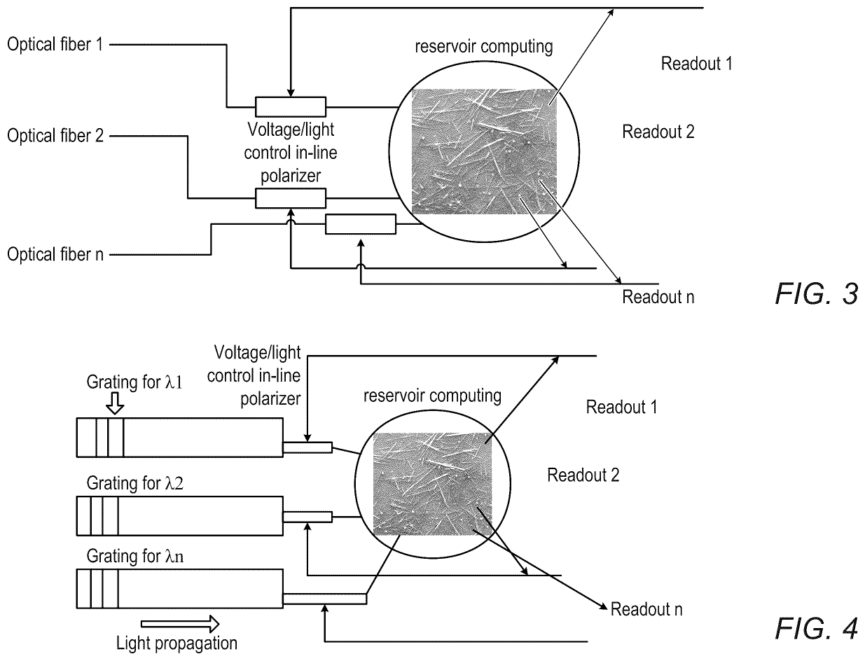

FIG. 3 shows an architecture of bio-organic based RC. Here, the RC is achieved by the randomness of self-assembled bio-organic structures. The reservoir computing unit (RCU) is composed of randomly oriented organic nanofibers. This can be collagen, peptides, amino-acids, silk, etc. that are self-assembled from solution, and dried on a substrate. Modulated or pulsed or CW light is coupled to the RCU by array of optical fibers. The incoming light hits a set of polarizers (could be optic-controlled, voltage-controlled, or fixed) that alter the Degree of Polarization (DoP) of the light at every input. The polarized light continues to the RCU, where eventually it goes to the readouts layer. The NN is realized either by taken an image of the RCU by polarizing camera, or detecting directly the propagating light by set of photodetectors positioned at the final layer (“readout layer”) of the RC. If the polarizer set is fixed, then the RC is considered “pre-trained”, and the DoP of every input is fixed and pre-determined. Training of the RC is done by feedback loop between the readout outputs (that generates electrical signals) fed to the voltage-controlled (in-line) polarizers that change the DoP of the input light until convergence.

In further embodiments, FIG. 4, the light can be coupled from free-space, for applications in optogenetics or from the sun. The input layer is consisting array of bio-organic microcrystals that are inscribed by lithography methods (such as Focused Ion Beam—FIB) to produce a DOE that couples light at specific angles and wavelengths.

In further embodiments, other architectures perform VMN from bio-organics. These architectures exploit the inherent optical property of photoluminescence (PL) of various organic crystals (for example, amyloid fibrils and proteins), which allows active (as well as passive) optical waveguiding. These architectures perform the WDM method but in a different way.

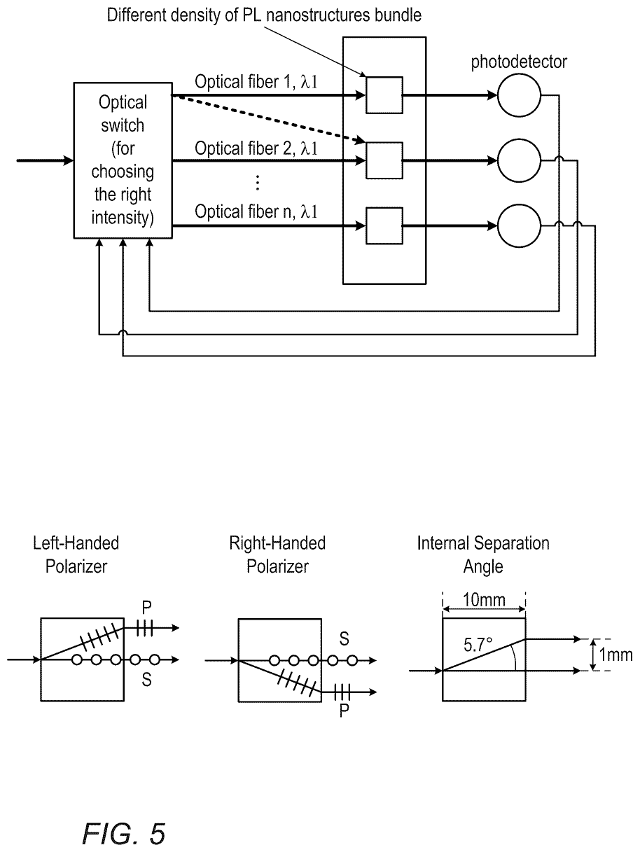

In FIG. 5, light at the input excites a dense pack of PL organic crystals. Each pack has different density—resulting in different PL intensity. The PL power of each pack corresponds to the weights of the convolution kernel. This way, each PL carries the signal with different weight amplitudes. The PL light is then transmitted (by process known as active waveguiding) to photodetector array where the signals are converted to electrical voltage/current. Training is done by feedback loop that changes the voltage in a voltage-controlled optical switch (for example, based on MEMS), or light-controlled switch, which launch the light to a different organic pack. If there is no feedback loop, one can program in advance and fix the input waveguides to the desired dense organic crystals, yielding a pre-trained NN. An example to passive light-controlled optical switch is Beam Displacer Modules (BDS), where the input polarization determines the displacement of the input light, and thus each input hits different dense organic pack. According to some embodiments, various light polarization angles and/or directions may be applied as part of the BDS. For example, left-handed polarizer and right-handed polarizer having an opposite internal separation angle, etc.

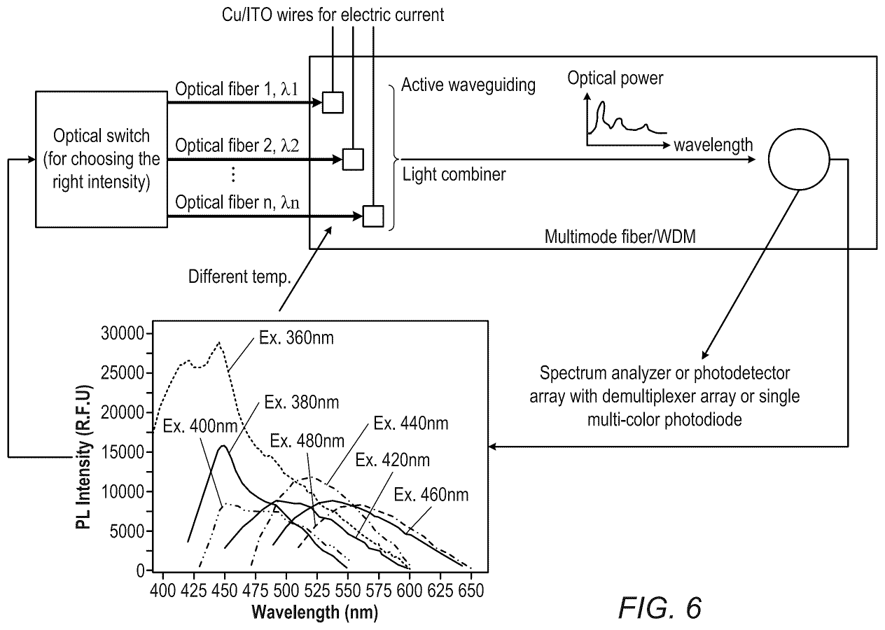

In further embodiments, illustrated in FIG. 6, incoming WDM signals at different wavelengths are weighted by equal-density organic fiber pack. Each pack is heated to different temperature or for different time at the same temperature. Once the organic packs are heated, they generate PL, but with fixed, unchangeable PL intensity, and each neuron's output is assigned a unique wavelength carrier that is wavelength division multiplexed and broadcast. Heating is done by incorporating conducting wires (i.e., from metals or TiO2) on top or beneath of organic crystal waveguide structures. The PL power of each pack corresponds to the weights of the convolution kernel. Light at many wavelengths is then combined by WDM device, and propagates to either a single multi-color photodetector or to DWDM followed by array of photodetectors, where the signals are summed by total power detection. Training is done by feedback loop that changes the voltage in a voltage-controlled (or light-controlled) optical switch (for example, based on MEMS), which launch the light to different organic pack. Example to materials that would generate such PL light is heated peptides and amino acids. If there is no feedback loop, one can program in advance and fix the input waveguides to the desired dense organic crystals, yielding a pre-trained NN.

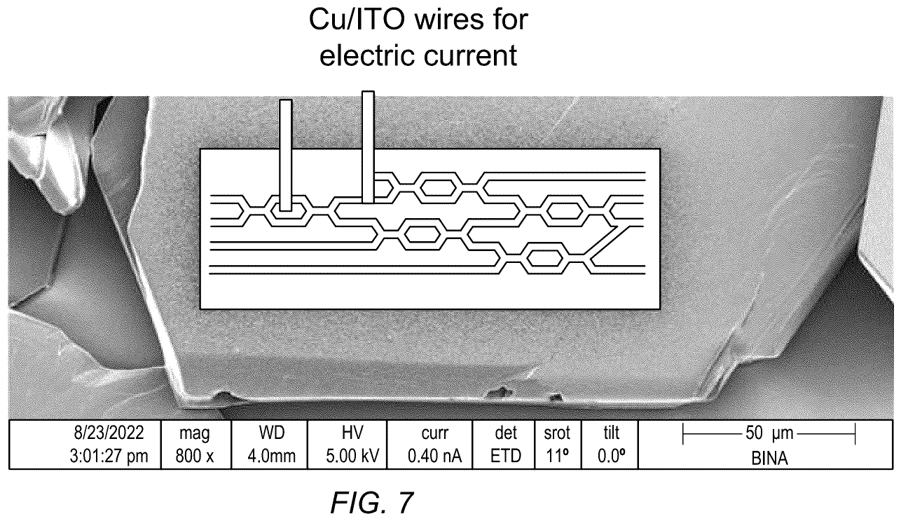

In further embodiments, illustrated in FIG. 7, an example to MZI-based photonic NN is realized by bio-organic materials exhibiting large electro-optic coefficient. In this example, the fabricated bio-organic material is Histidine amino acid. It was fabricated by the following procedure: Histidine (His) powder was first dissolved in 1,1,1,3,3,3-hexafluoro-2-propanol (HFIP) to an initial concentration of 100 mg/mL. Next, the solution was further diluted in 80% Ethanol and 20% deionized water. After mixing the solution, self-assembly process naturally occurs, yielding an irregular convex hexagonal crystal sheets. Finally, droplets of the above suspension were placed on a substrate and dried at room temperature inside a fume hood. Here, the organic microstructures are elongated, which may be treated as a “ridge” waveguide. An array of MZI may be generated by using FIB, 3D-printing, direct laser writing, or Nano Fountain Pen (NFP) methods. When using FIB or direct laser writing, the structures are inscribed on solid-state organic crystals, while in 3D-printing or NFP, a solution containing monomers of organic materials is loaded (in a nanopipettes, in case of NFP or to a chamber in case of 3D-printing), and then drawn to the substrate in a specific manner, which yields a pre-designed structure. Conductive wires may be also fabricated using various methods, such as sputtering, evaporating, or deposition (for example, Gallium deposition by FIB) on the arms of the MZI-array. Training is done by controlling externally the voltage of each MZI in the MZI array. Example to bio-organic materials exhibiting large electro-optic coefficient are poly-methyl methacrylate and amorphous polycarbonate, AJP12 polymers, etc.

In further embodiments, an optical nonlinearity unit (ONU) from biomaterials is constructed. The ONU is intended to execute the (all-optical) nonlinear activation function, and is not based on MZI or electro-optic conversion or inorganic materials. Activation function is realized by using another organic material (for example, g Poly [2-methoxy-5-(2-ethylhexyloxy)-1,4-phenylenevinylene] (MEH-PPV) organic semiconductor material as a saturable absorber) or the same organic material that includes addition of gold (Au) nanoparticles. Incorporation of gold nanoparticles in a host material is known to induce saturable absorption, which could be used to make the ONU.

In a further embodiment, the ANN processor will be operated in parallel by both electrical signals and optical signals. For example, conjugated π polymers (such as Polyacetylene (PA), polythiophene (PT), poly[3,4-(ethylenedioxy)thiophene] (PEDOT), polypyrrole (PPy), polyphenylene, and polyaniline (PANi)) may be incorporated into or integrated with optical waveguides. These polymeric waveguides can be used as the optical ANN processors (as detailed earlier) and also may conduct electricity for neuromorphic computation. An electric circuit containing a controller will operate the conductive polymers, which may be used as ordinary conductive wires, or will change their conductivity in response to external or internal parameters such as humidity, temperature, pressure etc. This way, the multiply-accumulate (MAC) operations are largely increased and the ANN processor may be used for both optical and electronic signals.

In a further embodiment, the photonic ANN processor will adopt an only feedforward architecture, without backpropagation. This architecture can be made if neuron j must be located before neuron k.

Any processing and control circuitry may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Various modifications of the disclosed embodiments, as well as alternative embodiments of the invention will become apparent to persons skilled in the art upon reference to the description of the invention. It is, therefore, contemplated that the appended claims will cover such modifications that fall within the scope of the invention.

1. An Artificial Neural Network (ANN) system, comprising:
(i) at least one edge computing device, and
(ii) at least one photonic ANN processor based on bio-organic materials,
wherein the ANN processor is designated to allow low latency computation capacities of the edge computing device comparing to an edge computing device that rely on cloud computing connectivity, and
wherein the system is configured to allow light propagation from input to output while giving each input proper weights in form of different intensity, wavelength or polarization.

2. The system on claim 1, further comprising an array of optical inputs comprised from bio-organic fibers and crystals.

3. The system on claim 1, further comprising multiple sensors configured to interact with the bio-organic photonic ANN processor as part of a medical or communication device apparatus located in close proximity to a patient.

4. The system on claim 3, wherein the integration with the sensing means enables to detect and analyze various biological parameters of the patient.

5. The system on claim 1, wherein the bio-organic materials are selected from a group that comprise conductive polymers, amino acids, proteins, peptides, amyloid fibrils.

6. A photonic ANN processor based on bio-organic materials that comprises a combination of inorganic and organic materials and includes a substrate made of resilient material/s.

7. The ANN processor of claim 6, wherein the substrate is made of biocompatible materials.

8. The ANN processor of claim 6, wherein the substrate is made of conductive materials.

9. The system of claim 6, wherein the resilient material/s allow the ANN processor to be integrated with or incorporated in various biological, electronical, optical or chemical devices, etc.

10. The system of claim 6, wherein the ANN processor is configured to operate in parallel by both electrical signals and optical signals.

11. The system of claim 6, wherein the ANN processor is configured to operate in only feedforward architecture, without backpropagation.

12. The system of claim 6, wherein the ANN processor further comprises bio-organic optical elements designated to provide both interconnection and/or summation and thresholding.
